(19) United States
(12) Patent Application Publication
(10) Pub. No.: US 2021/0107064 A1
(43) Pub. Date: Apr. 15, 2021

(54) Large-Scale Efficient Selective Laser Melting Forming Device

(71) Applicant: Chongqing University, Chongqing City (CN)

(72) Inventors: Zhengwen ZHANG, Chongqing City (CN); Peng ZHANG, Chongqing City (CN); Fei LIU, Chongqing City (CN); Jingwei DAI, Chongqing City (CN); Zhibo MA, Chongqing City (CN); Zhonghua LI, Chongqing City (CN); Donghua WEI, Chongqing City (CN); Tao ZHANG, Chongqing City (CN); Zhihao REN, Chongqing City (CN)

(21) Appl. No.: 16/634,470

(22) PCT Filed: Oct. 27, 2017
(86) PCT No.: PCT/CN2017/108083

§ 371 Date: Oct. 23, 2020

(30) Foreign Application Priority Data
Aug. 8, 2017 (CN) 201710669856.1

(51) Int. Cl. B22F 12/70; B22F 10/28; B22F 12/50; B22F 12/90; B22F 10/30; B33Y 30/00; B33Y 50/02

(52) U.S. Cl. CPC B22F 12/70; B22F 10/28; B22F 12/50; B33Y 50/02; B22F 10/30; B33Y 30/00; B22F 12/90

(57) ABSTRACT

A efficient large-scale selective laser melting forming device comprises a rack (1), a forming workbench (2) arranged on the rack, a forming bin (3) sleeved on the forming workbench and a galvanometer scanning device (7) arranged outside the forming bin and moving reciprocally along the powder spreading direction to form a multi-station working state, and a smoke blowing and sucking mechanism (8) arranged in the forming bin in a mode of synchronously moving to the same station with the galvanometer scanning device. The galvanometer scanning device can move reciprocally along the powder spreading direction to form a multi-station working state. The galvanometer scanning device is entirely arranged outside the forming bin. The smoke blowing and sucking mechanism arranged in the forming bin can synchronously move with the galvanometer scanning device to the same station.

### TECHNICAL FIELD

The present invention relates to a field of selective laser melting, and in particular, to a large-scale efficient selective laser melting forming device.

### BACKGROUND

Selective laser melting, also known as SLM, is a technology in which metal powder is completely melted under the action of heat of laser beam and formed by cooling and solidifying. Under the action of high laser energy density, the metal powder is completely melted, and after heat dissipation and cooling, it can be formed with solid metal metallurgy by welding. Selective laser melting goes through this process and forms three-dimensional solids by layer accumulation. According to the layered slice information of the three-dimensional CAD model of the forming part, the scanning system controls the laser beam to act on the powder in the area to be formed, after the scanning of one layer is completed, the work platform will fall the distance of a layer thickness and the powder feeding system will deliver a certain amount of powder, and the roller of the powder spreading system will spread the powder of a layer thickness deposited on the formed layer. Then, repeating the above two forming processes until all slice layers of all three-dimensional CAD models are scanned.

Due to the limitation of the scanning range of the optical galvanometer scanning system and the range of effective smoke blowing and sucking, the forming sizes of selective laser melting devices in the world are currently limited to a small size range, such as selective laser melting equipment M400 of German 3D printing company EOS whose maximum forming size is 400 mm×400 mm, SLM500 of SLM solutions company whose maximum forming size is 500 mm×280 mm, X LINE 2000R of Concept Laser company whose maximum forming size is 800 mm×400 mm, large-scale selective laser melting equipment is yet to be developed.

In order to develop large-scale selective laser melting device, there is a method of multi-galvanometer structure in the prior art, although it can be adapted to the forming of large-size workpieces, but excessive smoke and dust in the forming bin are caused due to the increase in size range, however, the laser system is extremely sensitive to dust, if the dust level is too high, it will easily cause greater damage, this requires timely and effective cleaning of a large amount of smoke generated during the laser processing, otherwise the quality of formed workpieces will be seriously affected, and even the processing process will be interrupted. And the selective laser melting process is carried out in an inert gas atmosphere, therefore, the selective laser melting device requires an efficient laser smoke filtering system to realize the filtering of smoke and recycling of inert gas.

Although there is a laser melting device which can remove smoke and dust in the forming bin in the prior art, its structure is complicated. And because it is also arranged in the forming bin, and in order to better ensure the effect of dust sucking, it is necessary to set the dust sucking device as close to the surface of the forming workbench as possible, in this way, it is easy to hinder the reciprocating movement of the scraper during the process of powder spreading; in addition, the laser melting equipment in the prior art which can remove smoke and dust in the forming bin is also not suitable for large-scale formed workpieces and cannot form a good fit with the existing multi-galvanometer structure.

Therefore, it is necessary to improve the existing laser melting forming device so that it can realize the forming of large-sized parts, overcome the issue of small forming size of single-galvanometer system, and reduce the space protection for inert gas, save the use of inert gas, and make the structure of the forming bin be compact, at the same time, based on the compact structure of the forming bin, it can realize the smooth realization of the removing of smoke and dust and does not interfere with the work of the scraper.

### SUMMARY

In light of this, the present invention provides a large-scale efficient selective laser melting forming device so that it can realize the forming of large-sized parts, overcome the issue of small forming size of single-galvanometer system, and reduce the space protection for inert gas, save the use of inert gas, and make the structure of the forming bin be compact, at the same time, based on the compact structure of the forming bin, it can realize the smooth realization of the removing of smoke and dust and does not interfere with the work of the scraper.

The large-scale efficient selective laser melting forming device of the present invention comprises a rack, a forming workbench arranged on the rack, a forming bin sleeved on the forming workbench and a galvanometer scanning device arranged outside the forming bin and moving reciprocally along the powder spreading direction to form a multi-station working state, and a smoke blowing and sucking mechanism arranged in the forming bin in a mode of synchronously moving to the same station with the galvanometer scanning device;

the galvanometer scanning device comprises a galvanometer beam arranged above the forming bin in a mode of moving reciprocally along the powder spreading direction and at least two galvanometer devices arranged on the galvanometer beam in parallel, there is an overlap area in the scanning area between adjacent galvanometer devices;

the smoke blowing and sucking mechanism comprises a support plate arranged on the side wall of the forming bin in a mode of moving reciprocally along the powder spreading direction, and a smoke blowing and sucking frame arranged in cooperation with the support plate in a mode of relatively moving up and down.

Further, a sealing top cover is arranged on the upper side of the forming bin, and a set of lenses is arranged on the sealing top cover corresponding to each station of the galvanometer scanning device, the number of lenses in each set of lenses is the same as the number of galvanometer device.

Further, the smoke blowing and sucking frame comprises a smoke blowing mouth and a smoke sucking mouth arranged oppositely, and connecting plate part for connecting the ends of smoke blowing mouth and the smoke sucking mouth and cooperating with the support plate in a mode of moving up and down.

Further, the large-scale efficient selective laser melting forming device further comprises a smoke filtering system that communicates with smoke blowing and sucking mechanism to form a loop, the smoke filtering system comprises a smoke blowing pipe communicating with the smoke blowing mouth, a smoke sucking pipe communicating with the smoke sucking mouth and a filtering device communicating with an air outlet end of the smoke sucking pipe, an air inlet end of the smoke blowing pipe is in communication with an air outlet end of the filtering device.

Further, the filtering device comprises a housing and a primary filtering cavity, a transition cavity, and a secondary filtering cavity formed in the housing and arranged along the airflow direction, at least two cartridge filters are arranged in parallel in the primary filtering cavity from top to bottom and their air outlet ends are in communication with the transition cavity, the lower end of the transition cavity forms a vent for communication with the secondary filtering cavity, the secondary filtering cavity is provided with a saturated filter; the filtering device further comprises a power generating device of smoke sucking arranged at the lower end of the transition cavity and a dust collecting barrel arranged in the housing and communicating with the lower end of the primary filtering cavity.

Further, a counter-blow nozzle is arranged in the transition cavity and directly opposite an inner cavity of each cartridge filter and used for cleaning the dust adsorbed on the outside of the cartridge filter.

Further, the large-scale efficient selective laser melting forming device further comprises a powder conveyor arranged outside the forming bin for open-close communication with a powder spreading mechanism arranged inside the forming bin, a powder collection bin arranged on the forming workbench for collecting excess powder and a powder circulation system for powder circulation between the powder collection bin and the powder conveyor, the powder circulation system comprises a vibrating screen for sieving the powder collected in the powder collection bin and a powder storage tank which corresponds respectively for open-close communication with the vibrating screen and the powder conveyor, the vibrating screen and the powder storage tank are fixed on the rack.

Further, the powder circulation system further comprises:

a first level sensor, which is arranged on the powder spreading mechanism and is used for detecting the high position of the powder in the powder spreading mechanism;
a second level sensor, which is arranged on the powder spreading mechanism and is used for detecting the low position of the powder in the powder spreading mechanism, when the powder position in the powder spreading mechanism is higher than the first level sensor, the communication between the powder conveyor and the powder spreading mechanism is closed; when the powder position in the powder spreading mechanism is lower than the second level sensor, the communication between the powder conveyor and the powder spreading mechanism is open;
a third level sensor, which is arranged on the powder conveyor and is used for detecting the level of the powder in the powder conveyor to feedback for controlling the start or stop of the powder conveyor;
a fourth level sensor, which is arranged in the powder storage tank and is used for detecting the level of the powder in the powder storage tank, when the powder height is lower than the fourth level sensor, the communication between the powder storage tank and the vibrating screen is open, when the powder height is higher than the fourth level sensor, the communication between the powder storage tank and the vibrating screen is closed.

Further, the large-scale efficient selective laser melting forming device further comprises a motion control system for driving the workbench to move up and down and hydraulically balancing, the motion control system comprises a screw driving mechanism arranged on both sides of the forming workbench and a hydraulic balancing system for supporting the forming workbench and hydraulically balancing its movement, the screw driving mechanism comprises a drive motor, a screw that is rotatably arranged around its axis and driven by the drive motor, and a slider that is arranged on the side of the forming workbench and can move linearly along the axis of the screw when the screw rotated.

Further, the hydraulic balancing system comprises a supporting cylinder and an electro-hydraulic proportional control system for adjusting the pressure of the supporting cylinder so that its support force matches the gravity of the forming workbench in real time.

The advantageous effects of the present invention are: the large-scale efficient selective laser melting forming device of the present invention, the galvanometer scanning device can move reciprocally along the powder spreading direction to form a multi-station working state, so that it can realize the forming of large-sized parts, overcome the issue of small forming size of single-galvanometer system, and the galvanometer scanning device is entirely arranged outside the forming bin, thus it can reduce the protection space for inert gas, save the use of inert gas, and make the structure of the forming bin be compact, at the same time, the smoke blowing and sucking mechanism arranged in the forming bin can synchronously move with the galvanometer scanning device to the same station, and it can realize the smooth realization of the removing of smoke and dust when laser sintering is conducted at different stations, and the smoke blowing and sucking frame of the smoke blowing and sucking mechanism can move up and down relative to the support plate, the scraper can be avoided when the scraper works, it does not interfere with the work of the scraper, greatly improving the entire structure compactness of the forming bin.

### DRAWINGS

Hereinafter, the present invention is further described in conjunction with drawings and embodiments:

FIG. 1 is a view of the entire structure of the present invention;

FIG. 2 is a view of the entire structure of the galvanometer scanning device of the present invention;

FIG. 3 is a view of the galvanometer scanning device of the present invention in the working state;

FIG. 4 is a view of the overlap area in the scanning of the galvanometer scanning device of the present invention;

FIG. 5 is a view of structure of the smoke blowing and sucking mechanism of the present invention;

FIG. 6 is a top view of structure of the smoke blowing and sucking mechanism of the present invention;

FIG. 7 is a view of structure of the filtering device of the present invention;

FIG. 8 is a view of the working of the powder circulation system of the present invention;

FIG. 9 is a view of the motion principle of the forming workbench of the present invention;

FIG. 10 is a view of the entire structure of the forming workbench of the present invention.

### DETAILED DESCRIPTION

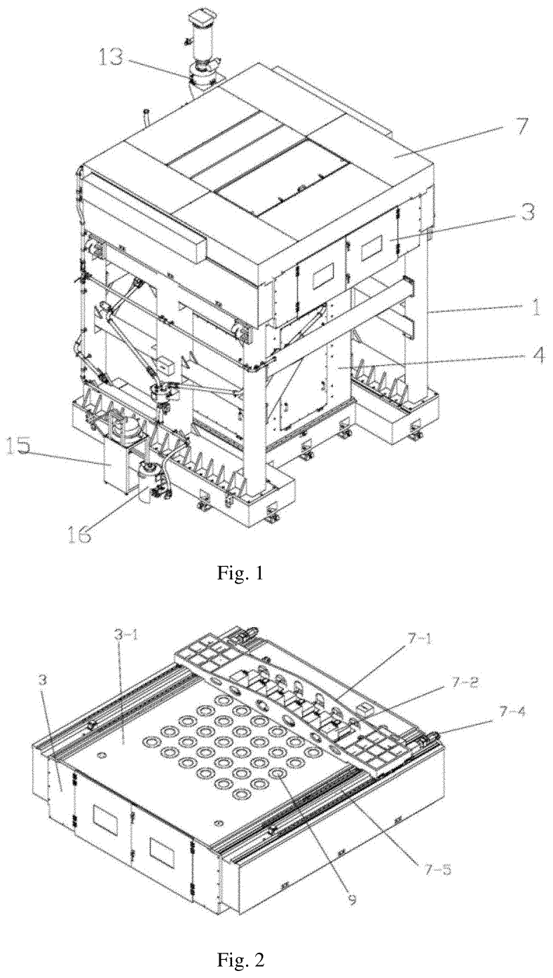

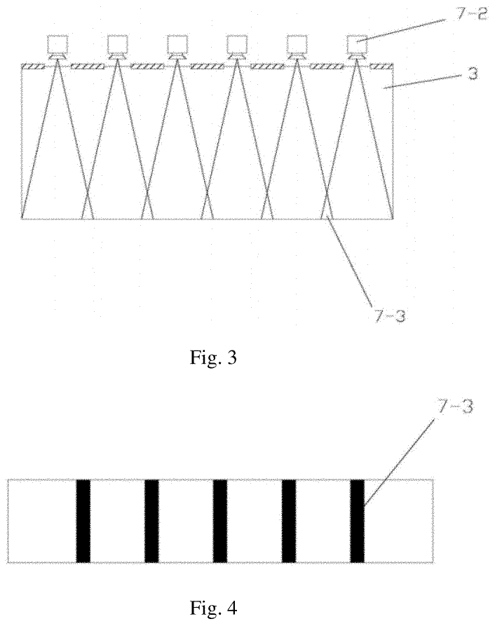

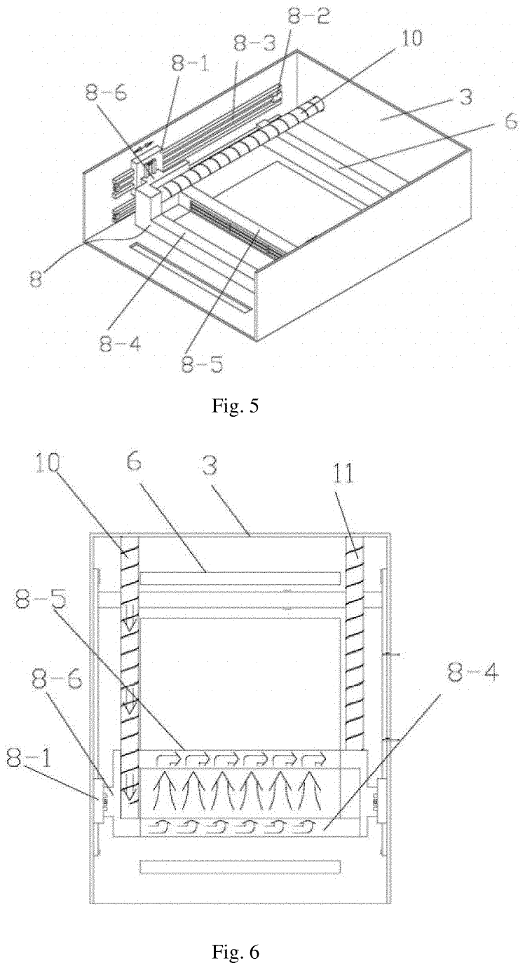

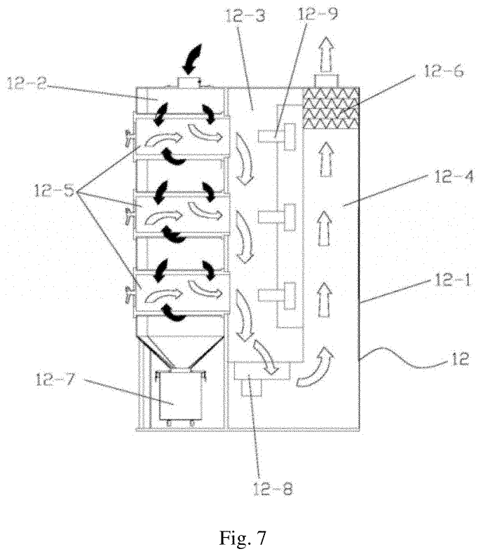

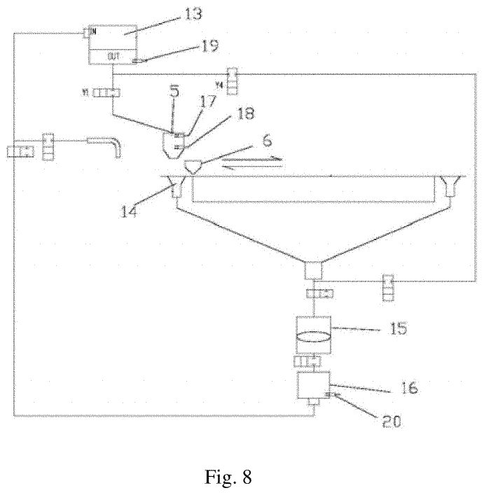

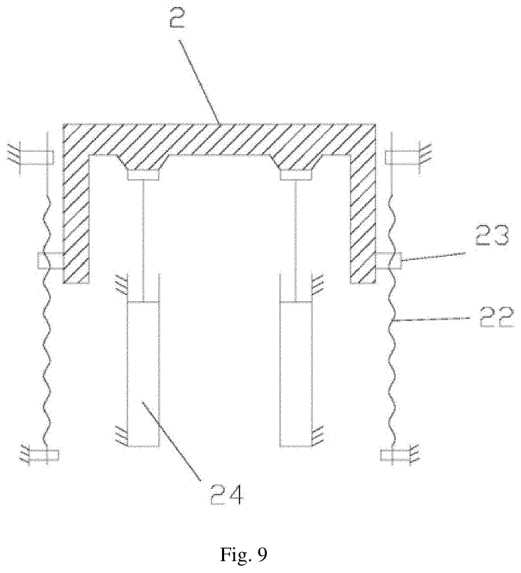

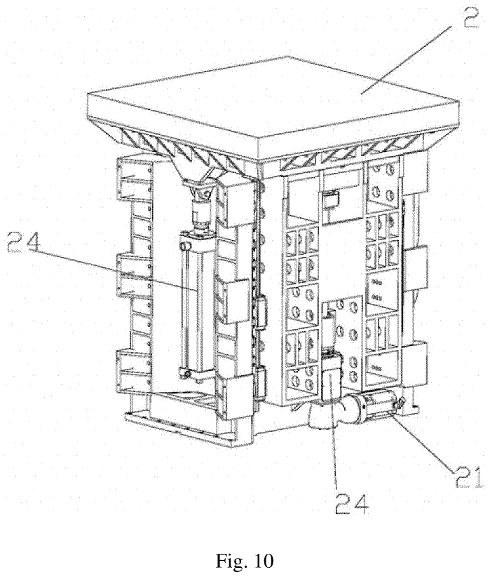

FIG. 1 is a view of the entire structure of the present invention. FIG. 2 is a view of the entire structure of the galvanometer scanning device of the present invention. FIG. 3 is a view of the galvanometer scanning device of the present invention in working state. FIG. 4 is a view of the overlap area in the scanning of the galvanometer scanning device of the present invention. FIG. 5 is a view of structure of the smoke blowing and sucking mechanism of the present invention. FIG. 6 is a view of structure of the filtering device of the present invention. FIG. 7 is a view of the working of the powder circulation system of the present invention. FIG. 8 is a view of an installation structure of the powder circulation system of the present invention. FIG. 9 is a view of the motion principle of the forming workbench of the present invention. FIG. 10 is a view of the entire structure of the forming workbench of the present invention. As shown in the figures: the large-scale efficient selective laser melting forming device of this embodiment comprises a rack 1, a forming workbench 2 arranged on the rack 1, a forming bin 3 sleeved on the forming workbench 2 and a galvanometer scanning device 7 arranged outside the forming bin 3 and moving reciprocally along the powder spreading direction to form a multi-station working state, and a smoke blowing and sucking mechanism 8 arranged in the forming bin 3 in a mode of synchronously moving to the same station with the galvanometer scanning device 7. The rack 1 is a frame structure, a forming workbench drive bin 4 is arranged outside the forming workbench 2, the forming workbench drive bin 4 is fixed on the rack 1, the forming workbench 2 is arranged in cooperation with the forming workbench drive bin 4 in a mode that can be moved up and down, the bottom surface of the forming bin 3 is arranged corresponding to the upper surface of the forming workbench 2, and the bottom of the forming bin 3 is fixedly connected to the rack 1, a powder spreading mechanism 5 and a scraper 6 are arranged in the forming bin 3, both of which are prior art, and are not repeated here. In addition, the galvanometer scanning device 7 is arranged outside the upper part of the forming bin 3, the galvanometer scanning device 7 can move reciprocally along the powder spreading direction to form multiple stations, the specific station control of the galvanometer scanning device 7 is controlled by a controller and a drive motor. The smoke blowing and sucking mechanism can also move reciprocally along the powder spreading direction, and synchronous co-station movement with galvanometer scanning device 7 is achieved by the control of the controller, so that smoke and dust can be removed at the station where the laser sintering is conducting.

The galvanometer scanning device 7 comprises a galvanometer beam 7-1 arranged above the forming bin 3 in a mode of moving reciprocally along the powder spreading direction and at least two galvanometer devices 7-2 arranged on the galvanometer beam 7-1 in parallel, there is an overlap area 7-3 in the scanning area between adjacent galvanometer devices 7-2. The galvanometer scanning device also comprises a scanning bin, the galvanometer device 7-2 is a laser galvanometer assembly. In this embodiment, six galvanometer devices 7-2 are arranged in parallel on the galvanometer beam 7-1, of course, it can also be two or other integer numbers greater than two, six galvanometer devices 7-2 scan simultaneously to achieve a scanning range of 1 m or more in the side-by-side direction. As shown in the FIG. 2, a beam drive motor 7-4 and a beam drive screw 7-5 for driving the galvanometer beam 7-1 to move are arranged on both sides outside the top of the forming bin 3 in parallel with the powder spreading direction, the beam drive screw 7-5 is supported on the forming bin 3 in a rotatable manner, the two ends of the galvanometer beam 7-1 are correspondingly arranged with beam drive sliders that perform linear reciprocating movement along thereof axial direction when the beam drive screw 7-5 rotated, each galvanometer device 7-2 is fixed on the upper side of the galvanometer beam 7-1 and irradiates downwards.

The smoke blowing and sucking mechanism 8 comprises a support plate 8-1 arranged on the side wall of the forming bin 3 in a mode of moving reciprocally along the powder spreading direction, and a smoke blowing and sucking frame arranged in cooperation with the support plate 8-1 in a mode of relatively moving up and down. As shown in the FIG. 5, smoke blowing and sucking drive mechanisms are provided on both side walls of the forming bin 3 in parallel with the powder spreading direction, the smoke blowing and sucking drive mechanism comprises a smoke blowing and sucking drive motor 8-2 and a smoke blowing and sucking drive screw 8-3, wherein, the smoke blowing and sucking drive screw 8-3 is supported on the inner wall of the forming bin 3 in a rotatable manner, the axial direction of the smoke blowing and sucking drive screw 8-3 and the axial direction of beam drive screw 7-5 are parallel and the same as the powder spreading direction, the support plate 8-1 is formed with a smoke blowing and sucking slider for linearly reciprocating along the axial direction of the smoke blowing and sucking drive screw 8-3 when the smoke blowing and sucking drive screw 8-3 is rotated by the smoke blowing and sucking drive motor 8-2. Similarly, the up and down movement of the smoke blowing and sucking frame relative to the support plate 8-1 is also realized by the screw slider mechanism, a rack drive screw is arranged on the support plate 8-1, a rack slider that reciprocates linearly along the axis of the rack drive screw is arranged on the smoke blowing and sucking frame, here the up and down movement of the smoke blowing and sucking frame refers to the movement of up and down direction perpendicular to the surface of the forming workbench 2, in this way, the smoke blowing and sucking frame can be moved in the powder spreading direction, and it can also be moved up and down in the vertical direction, therefore, it can not only realize the function of dust removal as the laser galvanometer moves during sintering, but also realize the avoidance of the scraper 6 by moving upward of the smoke blowing and sucking frame when the scraper 6 is working, thereby avoiding interference.

In this embodiment, a sealing top cover 3-1 is arranged on the upper side of the forming bin 3, and a set of lenses 9 is arranged on the sealing top cover 3-1 corresponding to each station of the galvanometer scanning device 7, the number of lenses in each set of lenses 9 is the same as the number of galvanometer device 7-2. The sealing top cover 3-1 guarantees the tightness of the forming bin 3 and can achieve inert atmosphere protection, and the galvanometer scanning devices 7 are isolated from the forming bin 3, thereby reducing the space for inert gas protection and saving the use of inert gas. In this embodiment, there are six sets of lenses, one set for each station, and six lenses for each set, the galvanometer scanning device 7 can achieve six-station movement due to those lenses, in this embodiment, the range of the six sets of lenses is not less than 1 m.

In this embodiment, the smoke blowing and sucking frame comprises a smoke blowing mouth 8-4 and a smoke sucking mouth 8-5 arranged oppositely, and connecting plate part 8-6 for connecting the ends of smoke blowing mouth 8-4 and the smoke sucking mouth 8-5 and cooperating with support plate 8-1 in a mode of moving up and down. As shown in the FIG. 5, the smoke blowing and sucking frame is integrally formed, wherein the smoke blowing mouth 8-4 and the smoke sucking mouth 8-5 are oppositely arranged, i.e. the direction of the air flow from the smoke blowing mouth 8-4 is directly opposite the smoke sucking mouth 8-5, the air port for sucking the airflow by the smoke sucking mouth 8-5 is directly opposite the air outlet port of the smoke blowing mouth 8-4. A working area of dust sucking is formed between the smoke blowing mouth 8-4 and smoke sucking mouth 8-5. As the smoke blowing and sucking mechanism 8 follows the synchronous co-station movement of galvanometer scanning device 7, the working area of dust sucking is also the real-time laser sintering area of the formed workpiece, thereby forming targeted dust sucking and dust removing and realizing effective atmosphere protection in the large-sized laser processing area.

In this embodiment, the large-scale efficient selective laser melting forming device further comprises a smoke filtering system that communicates with the smoke blowing and sucking mechanism to form a loop. The smoke filtering system comprises a smoke blowing pipe 10 communicating with the smoke blowing mouth 8-4, a smoke sucking pipe 11 communicating with the smoke sucking mouth 8-5 and a filtering device 12 communicating with an air outlet end of the smoke sucking pipe 11, an air inlet end of the smoke blowing pipe 10 is in communication with an air outlet end of the filtering device 12. The filtering device 12 comprises a housing 12-1 and a primary filtering cavity 12-2, a transition cavity 12-3, and a secondary filtering cavity 12-4 formed in the housing 12-1 and arranged along the airflow direction. At least two cartridge filters 12-5 are arranged in parallel in the primary filtering cavity 12-2 from top to bottom and their air outlet ends are in communication with the transition cavity 12-3, the lower end of the transition cavity 12-3 forms a vent for communication with the secondary filtering cavity 12-4, the secondary filtering cavity 12-4 is provided with a saturated filter 12-6; the filtering device 12 further comprises a power generating device of smoke sucking 12-8 arranged at the lower end of the transition cavity 12-3 and a dust collecting barrel 12-7 arranged in the housing 12-1 and communicating with the lower end of the primary filtering cavity 12-2. As shown in the FIG. 6, the primary filtering cavity 12-2, the transitional cavity 12-3, and the secondary filtering cavity 12-4 are formed in the housing 12-1 of the filtering device 12 by partitions, wherein, in the transitional cavity 12-3, the airflow direction is from top to bottom, and enters the secondary filter cavity 12-4 from the lower vent; in the secondary filter cavity 12-4, the airflow direction is from bottom to top, the saturated filter 12-6 is arranged at an air outlet of the secondary filter cavity 12-4 (i.e., the air outlet of the entire filter device 12). And, as shown in the FIG. 6, in the primary filtering cavity 12-2, three cartridge filters 12-5 are arranged in parallel from top to bottom, increasing the filtering area can greatly improve the filtering effect. In addition, the power generating device of smoke sucking is composed of a fan and a motor which are correspondingly arranged at the lower end of the secondary filter cavity 12-4 to form a ventilation effect, and the smoke blowing pipe 10 is also provided with a power generating device of smoke blowing which can be a blower or other fan that produces a blowing effect, both the smoke blowing pipe 10 and the smoke sucking pipe 11 are retractable hose structures to prevent influences on the movement of the smoke blowing and sucking frame.

In the prior art, when a large-sized workpiece is formed by laser sintering, the equipment runs for a long time, and a large amount of smoke and dust adsorbed on the surface of the filter will block the filter, which needs to be cleaned or replaced regularly. If the dust is cleaned or the filter is replaced during the processing, the processing will inevitably be stopped, which not only prolongs the processing time, but also needs to be inflated again to cause waste of inert gas. The large-scale efficient selective laser melting forming device of the present invention adopts a smoke filtering system, which can filter smoke, and can prevent the dust from being adsorbed on the surface of the filter to block the filter, there is no need to clean the dust or replace the filter during processing, which greatly improves the work efficiency and reduces processing time without wasting inert gas.

In this embodiment, a counter-blow nozzle 12-9 is arranged in the transition cavity 12-3 and directly opposite an inner cavity of each cartridge filter 12-5 and used for cleaning the dust adsorbed on the outside of the cartridge filter 12-5. As shown in the FIG. 6, the counter-blow nozzle is fixed on the cavity wall of the transition cavity 12-3.

Through the co-use of the smoke blowing and sucking mechanism 8 and the smoke filtering system, it can not only effectively filter out the smoke and dust in the inert gas, obtain clean gas, realize the recycling of the inert gas, but also use the inert gas to automatically counter-blow clean the dust adsorbed on the outer wall of the cartridge filter 12-5, thus making the filter can be cleaned during the process and making it possible for the device to run stably for a long time.

In this embodiment, the large-scale efficient selective laser melting forming device further comprises a powder conveyor 13 arranged outside the forming bin 3 for open-close communication with a powder spreading mechanism 5 arranged inside the forming bin 3, a powder collection bin 14 arranged on the forming workbench 2 for collecting excess powder and a powder circulation system for powder circulation between the powder collection bin 14 and the powder conveyor 13. The powder circulation system comprises a vibrating screen 15 for sieving the powder collected in the powder collection bin 14 and a powder storage tank 16 which corresponds respectively for open-close communication with the vibrating screen 15 and the powder conveyor 13, the vibrating screen 15 and the powder storage tank 16 are fixed on the rack 1. Wherein, the powder conveyor 13 is a vacuum powder conveyor 13, the entire powder circulation system uses a mode of bottom-up powder returning, and uses the airflow formed by the pressure difference to transfer the powder in the powder storage tank 16 to the vacuum powder conveyor 13, the powder is conveyed to the powder spreading mechanism 5 under the action of gravity, the powder spreading mechanism 5 conveys the powder to the scraper 6 by the roller, the scraper 6 spreads the powder onto the forming workbench 2 and scrapes the excess powder to the powder collecting bin 14, the powder is conveyed to the ultrasonic vibrating screen 15 under the action of gravity, the ultrasonic vibrating screen 15 removes the smoke and dust impurities in the powder and then conveys the powder in which the smoke and dust impurities have been removed to the powder storage tank 16, thus realizing the recycling of powder. During the processing, large-scale selective laser melting forming device requires a large amount of powder raw materials, if small equipment is used to manually add powder, it will inevitably bring a huge amount of labor, and the equipment cannot run continuously and stably for a long time, therefore, it is necessary to realize automatic powder supplying, powder spreading and recycling of powder in the equipment.

In this embodiment, the powder circulation system further comprises:

a first level sensor 17, which is arranged on the powder spreading mechanism 5 and is used for detecting the high position of the powder in the powder spreading mechanism 5;
a second level sensor 18, which is arranged on the powder spreading mechanism 5 and is used for detecting the low position of the powder in the powder spreading mechanism 5, when the powder position in the powder spreading mechanism 5 is higher than the first level sensor 17, the communication between the powder conveyor 13 and the powder spreading mechanism 5 is closed; when the powder position in the powder spreading mechanism 5 is lower than the second level sensor 18, the communication between the powder conveyor 13 and the powder spreading mechanism 5 is open;
a third level sensor 19, which is arranged on the powder conveyor 13 and is used for detecting the level of the powder in the powder conveyor 13 to feedback for controlling the start or stop of the powder conveyor 13;
a fourth level sensor 20, which is arranged on the powder storage tank 16 and is used for detecting the level of the powder in the powder storage tank 16, when the powder height is lower than the fourth level sensor, the communication between the powder storage tank 16 and the vibrating screen 15 is open, when the powder height is higher than the fourth level sensor, the communication between the powder storage tank 16 and the vibrating screen 15 is closed.

In this embodiment, the large-scale efficient selective laser melting forming device further comprises a motion control system for driving the workbench to move up and down and hydraulically balancing, the motion control system comprises a screw drive mechanism arranged on both sides of the forming workbench 2 and a hydraulic balancing system for supporting the forming workbench 2 and hydraulically balancing its movement, the screw drive mechanism comprises a drive motor 21, a screw 22 that is rotatably arranged around its axis and driven by the drive motor 21, and a slider 23 that is arranged on the side of the forming workbench 2 and can move linearly along the axis of the screw when the screw 22 rotated. The hydraulic balancing system comprises a support cylinder 24 and an electro-hydraulic proportional control system for adjusting the pressure of the support cylinder so that its support force matches the gravity of the forming workbench 2 in real time. Wherein, the screw is rotatably supported and arranged on the bin of the forming workbench drive bin 4, in order to withstand the wide range of weight changes of the forming workbench 2, the electro-hydraulic proportional control is used to adjust the pressure of the hydraulic system to ensure that the supporting force of the supporting cylinder matches the gravity of the forming workbench in real time. The electro-hydraulic proportional control system comprises a electro-hydraulic controller, an amplifier, a proportional pressure reducing valve and a pressure sensor, the pressure sensor is arranged in the rodless cavity of the supporting cylinder for detecting the cylinder pressure, the electro-hydraulic controller is used to receive a given control signal input from the master control unit of the laser melting forming device, the pressure sensor is connected to the electro-hydraulic controller and inputs the detected pressure signal into the electro-hydraulic controller, the electro-hydraulic controller compares the pressure signal detected by the pressure sensor with the given control signal and obtains a deviation signal by comparing, the electro-hydraulic controller is connected to the amplifier, the amplifier is connected to the proportional pressure reducing valve, the proportional pressure reducing valve is connected to the supporting cylinder, the deviation signal is input to the amplifier, amplified by the power, and then input to the proportional pressure reducing valve, then control the proportional pressure reducing valve to adjust the pressure and flow of the supporting cylinder, thereby achieving calibration adjustment, making that the supporting force of the supporting cylinder matches the gravity of the forming workbench in real time. Based on the process characteristics of selective laser melting layer-by-layer processing, in the process of forming parts, the forming workbench gradually falls, and the weight will gradually increase, for a workbench with a small forming area, the change in the weight of the forming workbench has little effect on the transmission mechanism, but for a workbench with a big forming area, when forming parts, the transmission mechanism relying only on ball and screw cannot withstand a wide range of weight changes on the workbench, therefore, the hydraulic system is required to realize the counterweight, the synchronous drive of the servo motor and the electro-hydraulic proportional control are applied to the selective laser melting large-scale heavy-duty workbench for controlling, and controlling thickness of the processing layer precisely.

Finally, it is to be explained that, the above embodiments are only used to explain the technical solutions of the present invention, but not to limit the present invention. Although the present invention is explained in detail with reference to preferred embodiments, those skilled in the art should understand that, without departing from the gist and the scope of the technical solutions of the present invention, modifications or equivalent substitutions may be made to the technical solutions of the present invention, which are to be covered by the scope of the claims of the present invention.

1-10. (canceled)

11. A large-scale efficient selective laser melting forming device comprising a rack, a forming workbench arranged on the rack, a forming bin sleeved on the forming workbench, a galvanometer scanning device arranged outside the forming bin and movable reciprocally along the powder spreading direction to form a multi-station working state, and a smoke blowing and sucking mechanism arranged in the forming bin in a mode of synchronously moving to the same station with the galvanometer scanning device;
the galvanometer scanning device comprises a galvanometer beam arranged above the forming bin in a mode of moving reciprocally along the powder spreading direction and at least two galvanometer devices arranged on the galvanometer beam in parallel, whereby there is an overlap area in the scanning area between adjacent galvanometer devices;
the smoke blowing and sucking mechanism comprises a support plate arranged on the side wall of the forming bin in a mode of moving reciprocally along the powder spreading direction, and a smoke blowing and sucking frame arranged in cooperation with the support plate in a mode of relatively moving up and down.

12. The large-scale efficient selective laser melting forming device according to claim 11, wherein:
a sealing top cover is arranged on the upper side of the forming bin;
a set of lenses is arranged on the sealing top cover corresponding to each station of the galvanometer scanning device; and
the number of lenses in each set of lenses is the same as the number of galvanometer device.

13. The large-scale efficient selective laser melting forming device according to claim 11, wherein the smoke blowing and sucking frame comprises a smoke blowing mouth and a smoke sucking mouth arranged oppositely, and a connecting plate part for connecting the ends of the smoke blowing mouth and the smoke sucking mouth and cooperating with the support plate in a mode of moving up and down.

14. The large-scale efficient selective laser melting forming device according to claim 11, wherein:
the large-scale efficient selective laser melting forming device further comprises a smoke filtering system that communicates with the smoke blowing and sucking mechanism to form a loop; and
the smoke filtering system comprises a smoke blowing pipe communicating with the smoke blowing mouth, a smoke sucking pipe communicating with the smoke sucking mouth, and a filtering device communicating with an air outlet end of the smoke sucking pipe, an air inlet end of the smoke blowing pipe is in communication with an air outlet end of the filtering device.

15. The large-scale efficient selective laser melting forming device according to claim 12, wherein:
the large-scale efficient selective laser melting forming device further comprises a smoke filtering system that communicates with the smoke blowing and sucking mechanism to form a loop; and
the smoke filtering system comprises a smoke blowing pipe communicating with the smoke blowing mouth, a smoke sucking pipe communicating with the smoke sucking mouth, and a filtering device communicating with an air outlet end of the smoke sucking pipe, an air inlet end of the smoke blowing pipe is in communication with an air outlet end of the filtering device.

16. The large-scale efficient selective laser melting forming device according to claim 13, wherein:
the large-scale efficient selective laser melting forming device further comprises a smoke filtering system that communicates with the smoke blowing and sucking mechanism to form a loop; and
the smoke filtering system comprises a smoke blowing pipe communicating with the smoke blowing mouth, a smoke sucking pipe communicating with the smoke sucking mouth, and a filtering device communicating with an air outlet end of the smoke sucking pipe, an air inlet end of the smoke blowing pipe is in communication with an air outlet end of the filtering device.

17. The large-scale efficient selective laser melting forming device according to claim 14, wherein:
the filtering device comprises a housing, a primary filtering cavity, a transition cavity, and a secondary filtering cavity formed in the housing and arranged along the airflow direction, at least two cartridge filters are arranged in parallel in the primary filtering cavity from top to bottom, the at least two cartridge filters having air outlet ends in communication with the transition cavity, the lower end of the transition cavity forms a vent for communication with the secondary filtering cavity, the secondary filtering cavity is provided with a saturated filter; and
the filtering device further comprises a power generating device of smoke sucking arranged at the lower end of the transition cavity, and a dust collecting barrel arranged in the housing and communicating with the lower end of the primary filtering cavity.

18. The large-scale efficient selective laser melting forming device according to claim 17, wherein a counter-blow nozzle is arranged in the transition cavity and directly opposite an inner cavity of each cartridge filter and usable for cleaning the dust adsorbed on the outside of the cartridge filter.

19. The large-scale efficient selective laser melting forming device according to claim 11, wherein the large-scale efficient selective laser melting forming device further comprises a powder conveyor arranged outside the forming bin for open-close communication with a powder spreading mechanism arranged inside the forming bin, a powder collection bin arranged on the forming workbench for collecting excess powder, and a powder circulation system for powder circulation between the powder collection bin and the powder conveyor, the powder circulation system comprises a vibrating screen for sieving the powder collected in the powder collection bin and a powder storage tank which corresponds respectively for open-close communication with the vibrating screen and the powder conveyor, the vibrating screen and the powder storage tank are fixed on the rack.

20. The large-scale efficient selective laser melting forming device according to claim 12, wherein the large-scale efficient selective laser melting forming device further comprises a powder conveyor arranged outside the forming bin for open-close communication with a powder spreading mechanism arranged inside the forming bin, a powder collection bin arranged on the forming workbench for collecting excess powder, and a powder circulation system for powder circulation between the powder collection bin and the powder conveyor, the powder circulation system comprises a vibrating screen for sieving the powder collected in the powder collection bin and a powder storage tank which corresponds respectively for open-close communication with the vibrating screen and the powder conveyor, the vibrating screen and the powder storage tank are fixed on the rack.

21. The large-scale efficient selective laser melting forming device according to claim 13, wherein the large-scale efficient selective laser melting forming device further comprises a powder conveyor arranged outside the forming bin for open-close communication with a powder spreading mechanism arranged inside the forming bin, a powder collection bin arranged on the forming workbench for collecting excess powder, and a powder circulation system for powder circulation between the powder collection bin and the powder conveyor, the powder circulation system comprises a vibrating screen for sieving the powder collected in the powder collection bin and a powder storage tank which corresponds respectively for open-close communication with the vibrating screen and the powder conveyor, the vibrating screen and the powder storage tank are fixed on the rack.

22. The large-scale efficient selective laser melting forming device according to claim 19, wherein the powder circulation system further comprises:
a first level sensor, which is arranged on a high position of the powder spreading mechanism and is usable for detecting whether there is powder in the high position of the powder spreading mechanism;
a second level sensor, which is arranged on a low position of the powder spreading mechanism and is usable for detecting whether there is powder in the low position of the powder spreading mechanism, when the powder position in the powder spreading mechanism is higher than the high position where the first level sensor is arranged on, the first level sensor detects the powder, the communication between the powder conveyor and the powder spreading mechanism is closed; when the powder position in the powder spreading mechanism is lower than the low position where the second level sensor is arranged on, neither the first level sensor nor the second level sensor detects the powder, the communication between the powder conveyor and the powder spreading mechanism is open;
a third level sensor, which is arranged on the powder conveyor and is usable for detecting whether there is powder in the position where the third level sensor is arranged on in the powder conveyor to feedback for controlling the start or stop of the powder conveyor; and
a fourth level sensor, which is arranged in the powder storage tank and is usable for detecting whether there is powder in the position where the fourth level sensor is arranged on in the powder storage tank, when the powder height is lower than the position where the fourth level sensor is arranged on, the fourth level sensor does not detect the powder, the communication between the powder storage tank and the vibrating screen is open, when the powder height is higher than the position where the fourth level sensor is arranged on, the fourth level sensor detects the powder, the communication between the powder storage tank and the vibrating screen is closed.

23. The large-scale efficient selective laser melting forming device according to claim 20, wherein the powder circulation system further comprises:
a first level sensor, which is arranged on a high position of the powder spreading mechanism and is usable for detecting whether there is powder in the high position of the powder spreading mechanism;
a second level sensor, which is arranged on a low position of the powder spreading mechanism and is usable for detecting whether there is powder in the low position of the powder spreading mechanism, when the powder position in the powder spreading mechanism is higher than the high position where the first level sensor is arranged on, the first level sensor detects the powder, the communication between the powder conveyor and the powder spreading mechanism is closed; when the powder position in the powder spreading mechanism is lower than the low position where the second level sensor is arranged on, neither the first level sensor nor the second level sensor detects the powder, the communication between the powder conveyor and the powder spreading mechanism is open;
a third level sensor, which is arranged on the powder conveyor and is usable for detecting whether there is powder in the position where the third level sensor is arranged on in the powder conveyor to feedback for controlling the start or stop of the powder conveyor; and
a fourth level sensor, which is arranged in the powder storage tank and is used for detecting whether there is powder in the position where the fourth level sensor is arranged on in the powder storage tank, when the powder height is lower than the position where the fourth level sensor is arranged on, the fourth level sensor does not detect the powder, the communication between the powder storage tank and the vibrating screen is open, when the powder height is higher than the position where the fourth level sensor is arranged on, the fourth level sensor detects the powder, the communication between the powder storage tank and the vibrating screen is closed.

24. The large-scale efficient selective laser melting forming device according to claim 21, wherein the powder circulation system further comprises:
a first level sensor, which is arranged on a high position of the powder spreading mechanism and is usable for detecting whether there is powder in the high position of the powder spreading mechanism;
a second level sensor, which is arranged on a low position of the powder spreading mechanism and is usable for detecting whether there is powder in the low position of the powder spreading mechanism, when the powder position in the powder spreading mechanism is higher than the high position where the first level sensor is arranged on, the first level sensor detects the powder, the communication between the powder conveyor and the powder spreading mechanism is closed; when the powder position in the powder spreading mechanism is lower than the low position where the second level sensor is arranged on, neither the first level sensor nor the second level sensor detects the powder, the communication between the powder conveyor and the powder spreading mechanism is open;
a third level sensor, which is arranged on the powder conveyor and is usable for detecting whether there is powder in the position where the third level sensor is arranged on in the powder conveyor to feedback for controlling the start or stop of the powder conveyor; and
a fourth level sensor, which is arranged in the powder storage tank and is usable for detecting whether there is powder in the position where the fourth level sensor is arranged on in the powder storage tank, when the powder height is lower than the position where the fourth level sensor is arranged on, the fourth level sensor does not detect the powder, the communication between the powder storage tank and the vibrating screen is open, when the powder height is higher than the position where the fourth level sensor is arranged on, the fourth level sensor detects the powder, the communication between the powder storage tank and the vibrating screen is closed.

25. The large-scale efficient selective laser melting forming device according to claim 11, wherein the large-scale efficient selective laser melting forming device further comprises a motion control system for driving the workbench to move up and down and hydraulically balancing, the motion control system comprises a screw driving mechanism arranged on both sides of the forming workbench and a hydraulic balancing system for supporting the forming workbench and hydraulically balancing its movement, the screw driving mechanism comprises a drive motor, a screw that is rotatably arranged around its axis and driven by the drive motor, and a slider that is arranged on the side of the forming workbench and can move linearly along the axis of the screw when the screw rotated.

26. The large-scale efficient selective laser melting forming device according to claim 12, wherein the large-scale efficient selective laser melting forming device further comprises a motion control system for driving the workbench to move up and down and hydraulically balancing, the motion control system comprises a screw driving mechanism arranged on both sides of the forming workbench and a hydraulic balancing system for supporting the forming workbench and hydraulically balancing its movement, the screw driving mechanism comprises a drive motor, a screw that is rotatably arranged around its axis and driven by the drive motor, and a slider that is arranged on the side of the forming workbench and can move linearly along the axis of the screw when the screw rotated.

27. The large-scale efficient selective laser melting forming device according to claim 13, wherein the large-scale efficient selective laser melting forming device further comprises a motion control system for driving the workbench to move up and down and hydraulically balancing, the motion control system comprises a screw driving mechanism arranged on both sides of the forming workbench and a hydraulic balancing system for supporting the forming workbench and hydraulically balancing its movement, the screw driving mechanism comprises a drive motor, a screw that is rotatably arranged around its axis and driven by the drive motor, and a slider that is arranged on the side of the forming workbench and can move linearly along the axis of the screw when the screw rotated.

28. The large-scale efficient selective laser melting forming device according to claim 25, wherein the hydraulic balancing system comprises a supporting cylinder and an electro-hydraulic proportional control system for adjusting the pressure of the supporting cylinder so that its support force matches the gravity of the forming workbench in real time.

29. The large-scale efficient selective laser melting forming device according to claim 26, wherein the hydraulic balancing system comprises a supporting cylinder and an electro-hydraulic proportional control system for adjusting the pressure of the supporting cylinder so that its support force matches the gravity of the forming workbench in real time.

30. The large-scale efficient selective laser melting forming device according to claim 27, wherein the hydraulic balancing system comprises a supporting cylinder and an electro-hydraulic proportional control system for adjusting the pressure of the supporting cylinder so that its support force matches the gravity of the forming workbench in real time.
